(19) United States
(12) Patent Application Publication
(10) Pub. No.: US 2016/0341692 A1
(43) Pub. Date: Nov. 24, 2016

(54) Electrolyte Measuring Apparatus and Electrolyte Measuring Method

(71) Applicant: JEOL Ltd., Tokyo (JP)

(72) Inventor: Atsuro Tonomura, Tokyo (JP)

(21) Appl. No.: 15/160,503

(22) Filed: May 20, 2016

(30) Foreign Application Priority Data
May 21, 2015 (JP) 2015-103866

(51) Int. Cl. G01N 27/416

(52) U.S. Cl. CPC G01N 27/4166

(57) ABSTRACT

An electrolyte measuring apparatus performs measurement of a potential of a standard solution, measurement of a potential of a diluent, and measurement of a potential of a specimen solution, when performing measurement of an electrolyte concentration. Then, the electrolyte measuring apparatus measures an electrolyte concentration of the specimen solution on the basis of the difference between the potential of the standard solution and the potential of the specimen solution. Furthermore, the electrolyte measuring apparatus determines presence/absence of an abnormality in an electrolyte concentration measurement state on the basis of the difference between the potential of the standard solution or the specimen solution and the potential of the diluent. The electrolyte measuring apparatus is able to detect an abnormality such as breakage or disconnection of an electrode connector or deterioration of an electrode, on the basis of determination as to presence/absence of an abnormality.

### CROSS-REFERENCE TO RELATED APPLICATION

This application claims priority to Japanese Patent Application No. 2015-103866 filed May 21, 2015, the disclosure of which is hereby incorporated in its entirety by reference.

### BACKGROUND OF THE INVENTION

1. Field of the Invention

The present invention relates to an electrolyte measuring apparatus and an electrolyte measuring method for measuring an electrolyte concentration on the basis of the difference in potential level between a specimen and a standard solution.

2. Description of the Related Art

In recent years, in the medical field or the like, ions dissolved in a specimen such as blood or urine, for example, sodium ion, potassium ion, chloride ion, etc., have been measured frequently.

For example, an electrolyte measuring apparatus is known which measures an electrolyte concentration (ion concentration) in a specimen such as urine or serum by using an ion-selective electrode. In addition, there is a flow type electrolyte measuring apparatus as one that measures a plurality of ions at one time.

Such an electrolyte measuring apparatus measures the potential of a specimen and also measures the potential of a standard solution by using a working electrode (ion-selective electrode) and a reference electrode, and measures an electrolyte concentration of a component to be measured included in the specimen, from measurement data of the specimen and the standard solution. That is, flow of measurement by the existing electrolyte measuring apparatus is shown in FIG. 6. The standard solution is supplied to a tank connected to the electrodes, to wash the tank with the standard solution (step S1). The standard solution is a solution of which a concentration is adjusted to a predetermined value beforehand. After the washing in step S1, the standard solution is supplied to the tank again, the potential of the standard solution within the tank is measured by the working electrode and the reference electrode (step S2). After the measurement, the standard solution within the tank is discharged. Then, a specimen solution obtained by mixing a specimen and a diluent is supplied into the tank, and the potential of the specimen solution is measured by the respective electrodes (step S3). Then, an arithmetic processing unit within the electrolyte measuring apparatus calculates an electrolyte concentration on the basis of the potential of the standard solution in step S2 and the potential of the specimen in step S3. Each time measurement is performed for one specimen as described above, washing with the standard solution is performed such that a measurement result is not influenced by another specimen measured last.

Japanese Unexamined Patent Application Publication No. 64-65441 discloses an example of an electrolyte measuring apparatus that performs such a measurement.

Meanwhile, in measuring an electrolyte concentration by the electrolyte measuring apparatus, absence of an abnormality in a measuring operation of the electrolyte measuring apparatus is important, but there is a problem that it is not possible to easily detect an abnormal state. For example, even when a connection state of a connector of the electrode for measuring the potential of a specimen is poor and there is breakage of a cable leading to the connector, the electrolyte measuring apparatus detects the potential of the standard solution and the potential of the specimen solution at the same level. The potential of the standard solution and the potential of the specimen being at the same level means that the measurement value of an electrolyte concentration is equal to a stable measured value, so that it is hitherto difficult to identify whether a proper measurement is performed. In addition, it is also difficult to easily determine an abnormality caused due to deterioration of the electrode itself to be used for measurement.

In the case of the electrolyte measuring apparatus disclosed in Japanese Unexamined Patent Application Publication No. 64-65441, a technique is described in which the potential level of a liquid serving as a reference (a standard solution) is compared before and after measurement of the potential of a specimen, to determine presence/absence of a measurement abnormality caused due to deterioration of the liquid serving as a reference. However, abnormalities in the electrolyte measuring apparatus include, in addition to deterioration of the liquid serving as a reference, various abnormalities such as breakage of a cable for the electrode and deterioration of the electrode itself, and proper detection of these abnormalities is desired.

### SUMMARY OF THE INVENTION

It is an object of the present invention to allow an abnormal state to be easily and accurately determined in measuring an electrolyte concentration by using an electrolyte measuring apparatus.

An electrolyte measuring apparatus according to preferred embodiments of the present invention includes: a dilution tank; a specimen supply unit configured to supply a specimen to the dilution tank; a diluent supply unit configured to supply a diluent to the dilution tank; a standard solution supply unit configured to supply a standard solution to the dilution tank; a measuring unit configured to measure a potential of a liquid supplied to the dilution tank, by using an electrode section including a working electrode and a reference electrode; and a control unit.

The control unit measures a potential of the standard solution supplied from the standard solution supply unit to the dilution tank, a potential of the diluent supplied from the diluent supply unit to the dilution tank, and a potential of a specimen solution obtained by mixing, in the dilution tank, the diluent supplied from the diluent supply unit and the specimen supplied from the specimen supply unit. Furthermore, the control unit determines an electrolyte concentration of the specimen on the basis of a difference between the potential of the standard solution and the potential of the specimen solution, and determines presence/absence of an abnormality on the basis of a difference between the potential of the standard solution or the specimen solution and the potential of the diluent.

An electrolyte concentration measuring method according to preferred embodiments of the present invention includes: a standard solution supplying step of supplying a standard solution to a dilution tank; a standard solution measuring step of measuring a potential of the standard solution supplied to the dilution tank in the standard solution supplying step; a standard solution discharging step of discharging the standard solution from the dilution tank after the standard solution measuring step; a diluent supplying step of supplying a diluent to the dilution tank after the standard solution discharging step; a diluent measuring step of measuring a potential of the diluent supplied to the dilution tank in the diluent supplying step; a diluent discharging step of discharging the diluent from the dilution tank after the diluent measuring step; a specimen solution supplying step of supplying the diluent and a specimen to the dilution tank to obtain a specimen solution after the diluent discharging step; a specimen solution measuring step of measuring a potential of the specimen solution supplied to the dilution tank in the specimen solution supplying step; a specimen solution discharging step of discharging the specimen solution from the dilution tank after the specimen solution measuring step; and an electrolyte concentration determining step of determining an electrolyte concentration of the specimen on the basis of a difference between the potential of the standard solution measured in the standard solution measuring step and the potential of the specimen solution measured in the specimen solution measuring step, and determining presence/absence of an abnormality on the basis of a difference between the potential of the standard solution measured in the standard solution measuring step or the potential of the specimen solution measured in the specimen solution measuring step and the potential of the diluent measured in the diluent measuring step.

According to the present invention, it is possible to measure the electrolyte concentration of the specimen on the basis of the potential of the standard solution and the potential of the specimen solution, and it is possible to determine presence/absence of an abnormality in measurement on the basis of the difference between the potential of the standard solution or the specimen solution and the potential of the diluent. Therefore, when an abnormality, such as breakage or disconnection of a connector for the electrode used for the measurement or deterioration of the electrode, occurs, it is possible to assuredly determine the abnormality, and it is possible to accurately determine a state where there is an abnormality in a measurement result.

### BRIEF DESCRIPTION OF THE DRAWINGS

FIG. 1 is a configuration diagram showing an example of an electrolyte measuring apparatus according to an embodiment of the present invention.

FIG. 2 is a flowchart showing an example of a measurement processing procedure by the electrolyte measuring apparatus according to the embodiment of the present invention.

FIG. 3 is a flowchart showing an example of an abnormality determination process by the electrolyte measuring apparatus according to the embodiment of the present invention.

FIGS. 4A to 4C are explanatory diagrams showing an example of potential measurement by the electrolyte measuring apparatus according to the embodiment of the present invention.

FIG. 5 is a flowchart showing an example of an abnormality determination process by an electrolyte measuring apparatus according to another embodiment of the present invention.

FIG. 6 is a flowchart showing an example of an existing electrolyte concentration measurement process.

### DESCRIPTION OF THE PREFERRED EMBODIMENTS

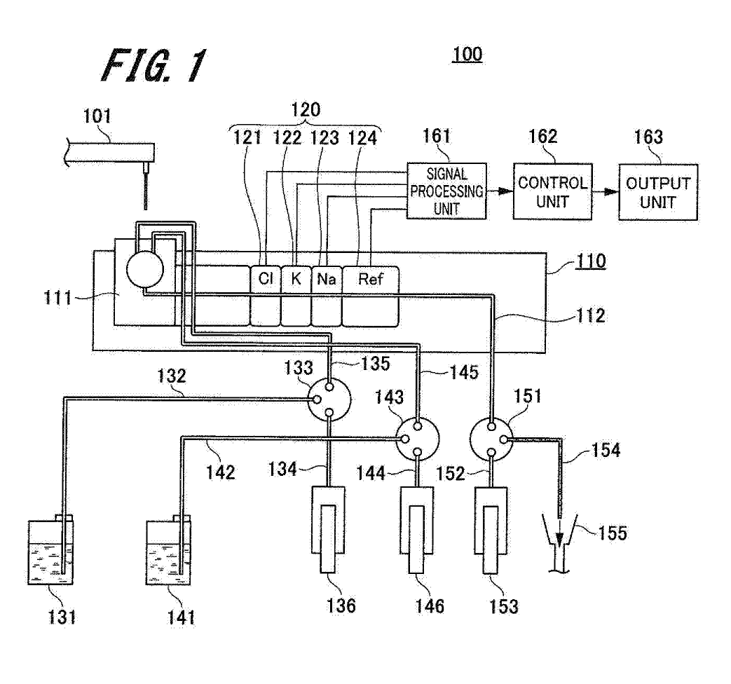

Hereinafter, an electrolyte measuring apparatus according to an embodiment of the present invention (hereinafter, referred to as “present example”) will be described with reference to FIGS. 1 to 5.

### [1. Configuration of Electrolyte Measuring Apparatus]

FIG. 1 shows an example of the configuration of an electrolyte measuring apparatus 100 according to the present example.

The electrolyte measuring apparatus 100 includes a measuring unit 110. An electrode section 120 is disposed in the measuring unit 110. Three working electrodes 121, 122, and 123 and a reference electrode 124 are disposed in the electrode section 120. The three working electrodes 121, 122, and 123 are composed of electrodes for ions to be measured. For example, the working electrode 121 is composed of a chlorine (Cl) ion electrode, the working electrode 122 is composed of a potassium (K) ion electrode, and the working electrode 123 is composed of a sodium (Na) ion electrode. In addition, the reference electrode 124 is an electrode for detecting a certain reference potential.

A liquid within a dilution tank 111 is supplied to the three working electrodes 121, 122, and 123 and the reference electrode 124, and a potential is detected by each of the electrodes 121 to 124.

The three working electrodes 121 to 123 and the reference electrode 124 are connected to a signal processing unit 161 via connectors or the like. The signal processing unit 161 detects potentials of the ions detected by the respective working electrodes 121 to 123, on the basis of the differences between the potentials detected by the working electrodes 121, 122, and 123 and the potential detected by the reference electrode 124. Data of the potential of each ion detected by the signal processing unit 161 is supplied to a control unit 162, and an ion concentration is calculated by the control unit 162. The value of the ion concentration calculated by the control unit 162 is outputted from an output unit 163.

The dilution tank 111 is disposed in the measuring unit 110. The dilution tank 111 is connected to a pump 153 via a pipe 112, a solenoid valve 151, and a pipe 152. The liquid within the dilution tank 111 is drawn to the pipe 112 side by suction of the pump 153. The liquid within the pipe 112 is supplied through the solenoid valve 151 via a pipe 154 to a waste liquid tank 155. The three working electrodes 121 to 123 and the reference electrode 124 are disposed on the pipe 112, and the electrodes 121 to 124 detect the potential of the liquid supplied from the dilution tank 111 to the pipe 112 by the suction of the pump 153.

A specimen is supplied to the dilution tank 111 from a specimen injection pipette 101 that is a specimen supply unit. The electrolyte measuring apparatus 100 includes a diluent container 131 and a standard solution container 141. A diluent for diluting a specimen is injected in the diluent container 131 that is a diluent supply unit. A standard solution that is a liquid having a concentration serving as a reference during measurement is injected in the standard solution container 141 that is a standard solution supply unit. The diluent has a concentration lower than that of the standard solution. In the present example, the diluent is used also when the dilution tank 111 is washed.

The diluent within the diluent container 131 is supplied to the dilution tank 111 side via a pipe 132, a solenoid valve 133, and a pipe 135. A pump 136 is connected to the solenoid valve 133 via a pipe 134. The diluent is supplied to the dilution tank 111 by discharge being performed by the pump 136.

Furthermore, the standard solution within the standard solution container 141 is supplied to the dilution tank 111 via a pipe 142, a solenoid valve 143, and a pipe 145. A pump 146 is connected to the solenoid valve 143 via a pipe 144. The standard solution is supplied to the dilution tank 111 by discharge being performed by the pump 146.

The supply of each liquid to the dilution tank 111 and the supply of the liquid within the dilution tank 111 to the waste liquid tank 155 side are performed under control of the control unit 162.

### [2. Measurement Procedure]

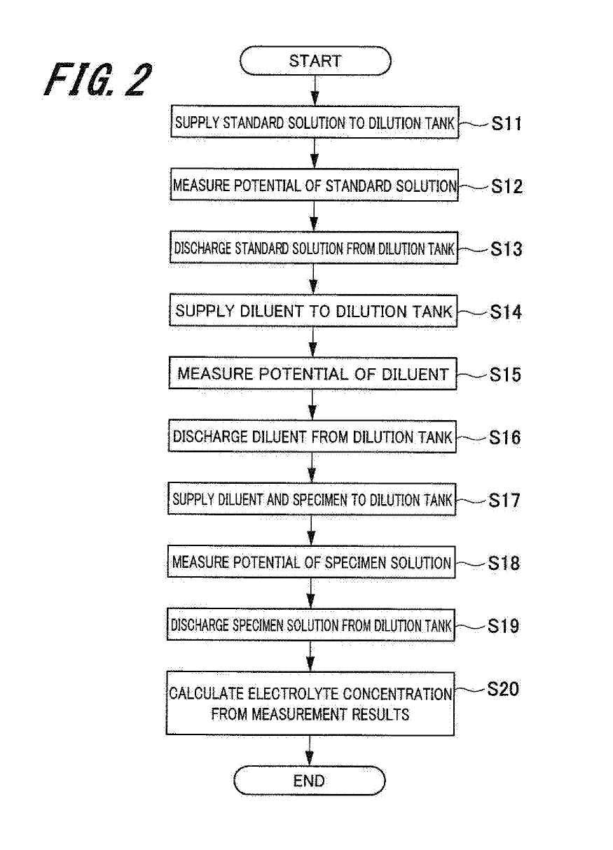

FIG. 2 is a flowchart showing a procedure when an electrolyte concentration of a specimen is measured by the electrolyte measuring apparatus 100.

First, the standard solution within the standard solution container 141 is supplied to the dilution tank 111 (step S11). Then, the potential of the standard solution within the dilution tank 111 is detected by the working electrodes 121 to 123 and the reference electrode 124, and the potential is measured by the signal processing unit 161 (step S12). Thereafter, the standard solution within the dilution tank 111 is discharged to the waste liquid tank 155 side (step S13).

Next, the diluent within the diluent container 131 is supplied to the dilution tank 111 (step S14). The pipe 112, on which the dilution tank 111 and the electrodes 121 to 124 are disposed, is washed with the diluent. Then, the potential of the diluent within the dilution tank 111 is detected by the working electrodes 121 to 123 and the reference electrode 124, and the potential is measured by the signal processing unit 161 (step S15). Thereafter, the diluent within the dilution tank 111 is discharged to the waste liquid tank 155 side (step S16).

Furthermore, the specimen is injected from the specimen injection pipette 101 to the dilution tank 111, the diluent within the diluent container 131 is supplied to the dilution tank 111, and a specimen solution obtained by mixing the specimen and the diluent within the dilution tank 111 is obtained (step S17). Then, the potential of the specimen solution within the dilution tank 111 is detected by the working electrodes 121 to 123 and the reference electrode 124, and the potential is measured by the signal processing unit 161 (step S18). Thereafter, the specimen solution within the dilution tank 111 is discharged to the waste liquid tank 155 side (step S19).

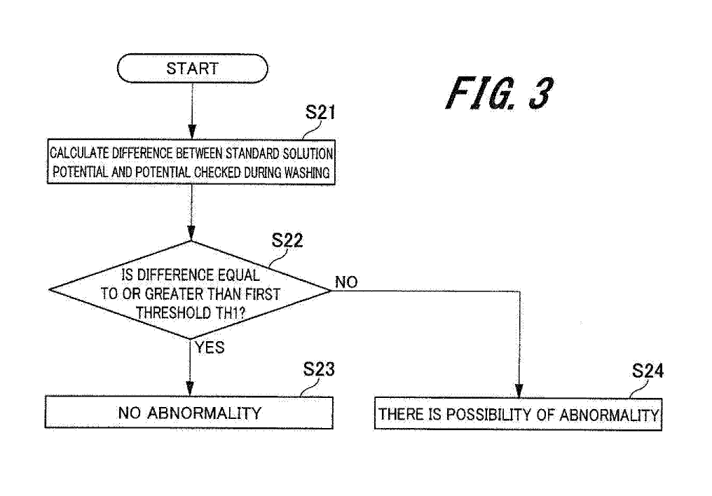

Then, the control unit 162 calculates an electrolyte concentration on the basis of the potential of the standard solution measured in step S12 and the potential of the specimen solution measured in step S18 (step S20). At this time, the control unit 162 determines whether there is an abnormality in the measurement. The process of determining whether there is an abnormality will be described in detail with reference to a flowchart in FIG. 3.

Here, if it is determined that there is no abnormality in the measurement, the control unit 162 outputs data of the calculated electrolyte concentration to the output unit 163.

The process shown in the flowchart in FIG. 2 described above is performed per single measurement of a single specimen.

### [3. Concentration Detection Process]

Next, a process of detecting the concentrations of the ions to be measured, on the basis of the potentials detected by the three working electrodes 121, 122, and 123 and the reference electrode 124, will be described.

First, a formula for obtaining an electromotive force on the basis of the potential detected by the working electrode 121, 122, or 123 and the potential detected by the reference electrode 124 is shown in formula (1).

$$E = {E}_{0} \pm ( 2.303 \times \frac{RT}{ZF} ) log a \qquad ( 1 )$$

In formula (1), E denotes a potential difference (mV) produced between the ion electrode and the reference electrode, E₀ denotes a certain potential (mV) determined by a measurement system, T denotes an absolute temperature (K), R denotes a gas constant, Z denotes a valency, F denotes the Faraday constant, and a denotes an ion activity.

Here, the term (2.303×RT/ZF) in formula (1) is a theoretical potential gradient and is generally referred to as slope. For example, in the case of a monovalent ion at 25° C., this term exhibits 59.16 mV.

In addition, the ion activity has a relationship of the following formula (2) between an activity coefficient and an ion concentration.

a=r×c (2)

In formula (2), a denotes the ion activity (mol/l), r denotes the activity coefficient, and c denotes the ion concentration.

The concentration of the specimen is calculated on the basis of the following formula (3) with the concentration C (IS) of the standard solution as a reference.

$$C ( S ) = C ( IS ) \times {10}^{\frac{E ( S ) - E ( IS )}{SL}} \qquad ( 3 )$$

In formula (3), C(S) denotes the concentration of the specimen (sample), and E(S) denotes the electromotive force of the specimen.

### [4. Abnormality Detection Process]

The flowchart in FIG. 3 shows an example of the process of the control unit 162 determining whether there is an abnormality in the measurement of the electrolyte concentration.

First, the control unit 162 calculates the difference between the potential of the standard solution measured in step S12 and the potential of the diluent measured in step S15 (step S21). Then, the control unit 162 determines whether the difference calculated in step S21 is equal to or greater than a first threshold TH1 (step S22). The first threshold TH1 is set in the control unit 162 beforehand.

If the difference calculated in step S21 is equal to or greater than the first threshold TH1 in the determination in step S22 (YES in step S22), the control unit 162 determines that there is no abnormality in the measurement results (step S23). In addition, if the difference calculated in step S21 is not equal to or greater than the first threshold TH1 in the determination in step S22 (NO in step S22), the control unit 162 determines that there is an abnormality in the measurement results (step S24).

If it is determined that there is an abnormality in the measurement results, for example, when data of the electrolyte concentration is outputted from the control unit 162 to the output unit 163, the control unit 162 adds, to the output data, information indicating that there is a possibility of an abnormality. The output unit 163 displays, for example, information indicating that there is a possibility of an abnormality in the measurement value.

### [5. Actual Measurement Example]

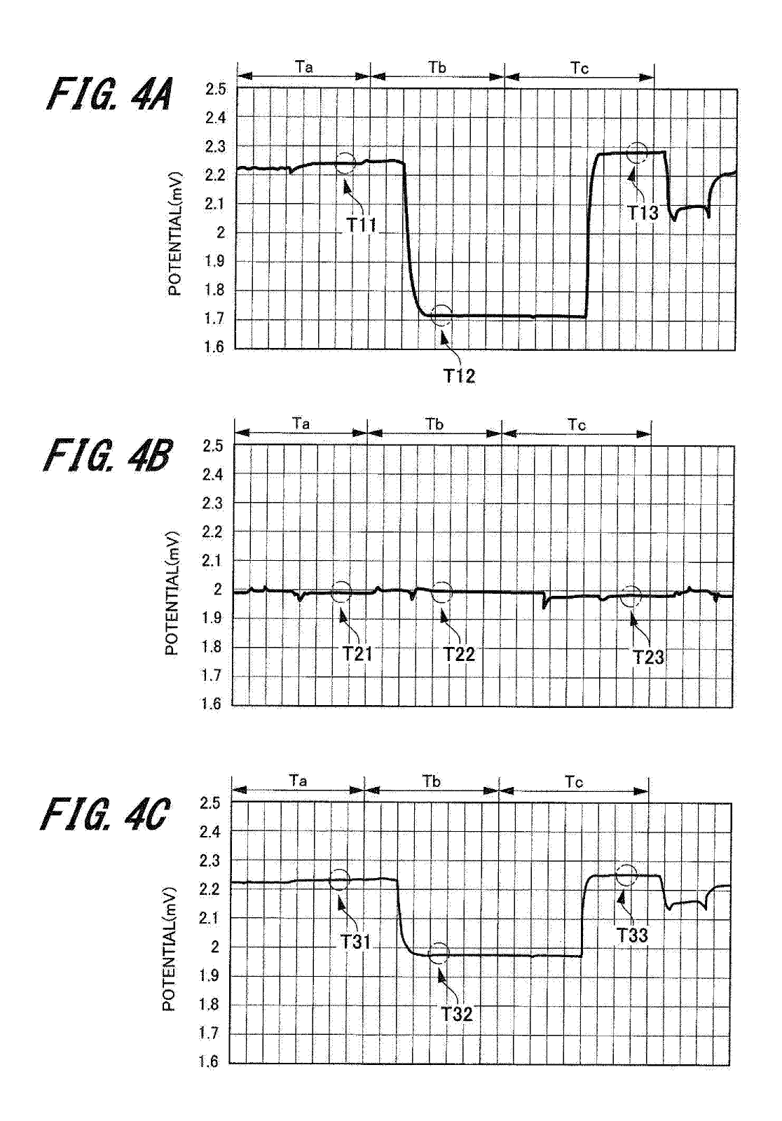

Next, a specific example of determining presence/absence of an abnormality will be described with reference to measurement examples in FIGS. 4A to 4C. In the respective measurement examples shown in FIGS. 4A to 4C, the vertical axis represents the potential (mV) of a measurement solution, and the horizontal axis represents time. In each example, a period Ta is a period in which a standard solution is put into the dilution tank 111 and measured. A period Tb is a period in which the diluent is put into the dilution tank 111 and measured. A period Tc is a period in which a specimen solution is put into the dilution tank 111 and measured.

FIG. 4A shows an example in the case where no abnormality is present and normal measurement is performed.

As shown in FIG. 4A, at timing T11 within the period Ta in which the standard solution is injected into the dilution tank 111 and measured, the potential of the standard solution is detected by the respective electrodes 121 to 124. Then, at timing T12 within the period Tb in which the diluent is injected into the dilution tank 111 and measured, the potential of the diluent is detected by the respective electrodes 121 to 124. Furthermore, at timing T13 within the period Tc in which the specimen solution is injected into the dilution tank 111 and measured, the potential of the specimen solution is detected by the respective electrodes 121 to 124.

Then, the concentration of the specimen is calculated on the basis of the potential of the standard solution detected at timing T11 and the potential of the specimen solution detected at timing T13.

In addition, the potential of the standard solution detected at timing T11 and the potential of the diluent detected at timing T12 are compared to each other. Here, since the measurement state is normal, there is a sufficient difference between the potential of the standard solution and the potential of the diluent. Therefore, in the control unit 162, in step S22 in the flowchart in FIG. 3, a potential difference equal to or greater than the first threshold TH1 is detected between the two potentials, and it is determined that the measurement state is normal.

When the example of the potential shown in FIG. 4A is described, the values measured at timings T11 and T12 are as follows.

Standard solution potential at timing T11: 2.240 mV
Diluent potential at timing T12: 1.722 mV

Therefore, [standard solution potential]−[diluent potential]=0.518 mV.

FIG. 4B shows an example of the value measured in the signal processing unit 161 in a state where the cable connecting the electrodes 121 to 124 to the signal processing unit 161 is broken or in a state where the connector has come off so that values detected by the electrodes 121 to 124 are not supplied to the signal processing unit 161.

In this example, at timing T21 within the period Ta in which the standard solution is injected into the dilution tank 111 and measured, the respective electrodes 121 to 124 measure the potential of the standard solution. Then, at timing T22 within the period Tb in which the diluent is injected into the dilution tank 111 and measured, the respective electrodes 121 to 124 measure the potential of the diluent. Furthermore, at timing T23 within the period Tc in which the specimen solution is injected into the dilution tank 111 and measured, the respective electrodes 121 to 124 measure the potential of the specimen solution. In this example, the measured values are not sent to the signal processing unit 161.

Therefore, as seen from FIG. 4B, there is almost no change in the potential of the standard solution at timing T21, the potential of the diluent at timing T22, and the potential of the specimen solution at timing T23, and a constant potential (approximately 2 mV in FIG. 4B) is detected. Therefore, in step S22 in the flowchart in FIG. 3, the control unit 162 does not determine that a potential difference equal to or greater than the first threshold TH1 is present between the two potentials, and determines that the measurement state is abnormal.

When the example of the potential shown in FIG. 4B is described, the values measured at timings T21 and T22 are as follows.

Standard solution potential at timing T21: 1.986 mV
Diluent potential at timing T22: 2.001 mV

Therefore, [standard solution potential]-[diluent potential]=−0.015 mV.

FIG. 4C shows an example of the value measured in the signal processing unit 161 in a state where, since the electrodes 121 to 124 have deteriorated, the potentials detected by the electrodes 121 to 124 have values different from the original potentials.

In this example, at timing T31 within the period Ta in which the standard solution is injected into the dilution tank 111 and measured, the potential of the standard solution is measured. Then, at timing T32 within the period Tb in which the diluent is injected into the dilution tank 111, the respective electrodes 121 to 124 measure the potential of the diluent. Moreover, at timing T33 within the period Tc in which the specimen solution is injected into the dilution tank 111, the respective electrodes 121 to 124 measure the potential of the specimen solution.

Here, as seen from comparison between FIG. 4A and FIG. 4C, the potential of the diluent detected at timing T32 decreases from the potential of the standard solution by a lower amount than the potential detected at timing T12 in the normal state (FIG. 4A). Therefore, in the control unit 162, in step S22 in the flowchart in FIG. 3, a potential difference equal to or greater than the first threshold TH1 is not detected between the two potentials, and it is determined that the measurement state is abnormal.

When the example of the potential shown in FIG. 4C is described, the values measured at timings T31 and T32 are as follows.

Standard solution potential at timing T31: 2.232 mV
Diluent potential at timing T32: 1.971 mV

Therefore, [standard solution potential]−[diluent potential]=0.261 mV.

As described above, according to the electrolyte measuring apparatus of the present example, the potential of the diluent is measured and compared to the potential of the standard solution, whereby it is made possible to easily and accurately determine whether there is an abnormality in a measurement state. Therefore, according to the electrolyte measuring apparatus of the present example, it is made possible to accurately prevent a wrong specimen concentration measurement value from being used as a measurement result. Any value may be used as the first threshold TH1 for determining whether the state is abnormal, as long as the value is within a range where it is possible to distinguish between the differential potential detected in FIG. 4A described above and the difference potentials detected in FIGS. 4B and 4C described above.

In addition, a threshold with which it is possible to detect an abnormality in which the difference between the potential of the diluent and the potential of the standard solution is greater than that in a normal state, may be set as a threshold, whereby it is made possible to determine an abnormal state caused due to the great potential difference. That is, when a potential difference greater than that in a state of a proper potential difference (the difference between the potential of the diluent and the potential of the standard solution) as shown in FIG. 4A by a predetermined value or greater is detected, it may be determined that the state is abnormal. Determination as to abnormality based on the potential difference being great may be performed simultaneously with determination as to abnormality based on the potential difference being small.

FIGS. 4A to 4C show two examples, a state where the cable is broken or a state where the connector has come off, and a state where the electrodes have deteriorated, as abnormal states. However, other abnormal states include opening/closing failure of the respective solenoid valves 133, 143, and 151, and occurrence of abnormal noise. Also at opening/closing failure of the respective solenoid valves or at occurrence of abnormal noise, there is a high possibility that a potential different from the potential in the normal state shown in FIG. 4A is detected, and it is determined in the electrolyte measuring apparatus of the present example that there is a possibility of an abnormal state.

[6. Other Embodiments (Example in which Abnormality Determination is Performed More Finely)]

In the abnormality determination process described with referenced to the flowchart in FIG. 3, it is determined only whether there is a possibility of an abnormality. On the other hand, the type of an abnormality may be identified.

FIG. 5 is a flowchart showing an example of the process in this case. In the flowchart in FIG. 5, a process in step S21 of calculating the difference between the potential of the standard solution and the potential of the diluent and a process in step S22 of determining whether the calculated difference is equal to or greater than the first threshold TH1 are the same as those in the flowchart in FIG. 3. Then, if the calculated difference is equal to or greater than the first threshold TH1 in step S22, the control unit 162 determines in step S23 that there is no abnormality in a measurement result, which is also the same as in the process in the flowchart in FIG. 3.

Then, in this example, when it is determined that the difference calculated in step S21 is not equal to or greater than the first threshold TH1 (NO in step S22), the control unit 162 further determines whether the difference calculated in step S21 is equal to or less than a second threshold TH2 (step S25). The second threshold TH2 is lower than the first threshold, and is set, for example, to a value with which it is possible to distinguish between a state where the cable for the electrode or the connector is disconnected (the state in FIG. 4B) and a state where the electrodes have deteriorated.

In step S25, when the difference calculated in step S21 is equal to or less than the second threshold TH2 (YES in step S25), the control unit 162 determines that there is a high possibility of an abnormality due to an apparatus failure such as disconnection of the electrode connector or breakage of the cable (step S26).

In addition, in step S25, when the difference calculated in step S21 is not equal to or less than the second threshold TH2 (NO in step S25), the control unit 162 determines that there is a high possibility of a failure caused due to deterioration of the electrodes 121 to 124 (step S27).

By finely determining the detected potential difference as described above, it is made possible to predict the cause of an abnormality. The cause of the abnormality predicted by the control unit 162 is, for example, outputted to the output unit 163 and displayed.

### [7. Modifications]

In the above-described embodiments, an abnormality in the concentration measuring apparatus is identified on the basis of the potential difference between the standard solution and the diluent. On the other hand, as is seen from the detection waveforms in FIGS. 4A to 4C, the substantially same potential difference is detected also for the potentials of the specimen solution and the diluent. Thus, the control unit 162 may determine whether there is a possibility that the measurement is abnormal, on the basis of the potential difference between the specimen solution and the diluent. However, the potential of the specimen solution shown in FIGS. 4A to 4C is an example, the potential of the specimen solution changes depending on the concentration of the specimen, and thus it is more preferable to detect the potential difference between the standard solution and the diluent for determining whether there is a possibility of an abnormality, than to detect the potential difference between the specimen solution and the diluent. Alternatively, the control unit 162 may determine both the potential difference between the standard solution and the diluent and the potential difference between the specimen solution and the diluent and synthetically determine whether the state is abnormal, on the basis of the respective potential differences.

In addition, the present invention is not limited to the aforementioned embodiments, and it should be understood that various applications and variations can be made as long as they do not depart from the scope of the present invention described in the appended claims. For example, the configuration of the measuring unit 110 and the arrangement of the respective electrodes 121 to 124 shown in FIG. 1 are examples, and the present invention is not limited to the configuration shown in FIG. 1. Moreover, values such as the potential shown in FIGS. 4A to 4C are examples, and the present invention is not limited to the values described with reference to FIGS. 4A to 4C, etc.

### DESCRIPTION OF REFERENCE NUMERALS AND SYMBOLS

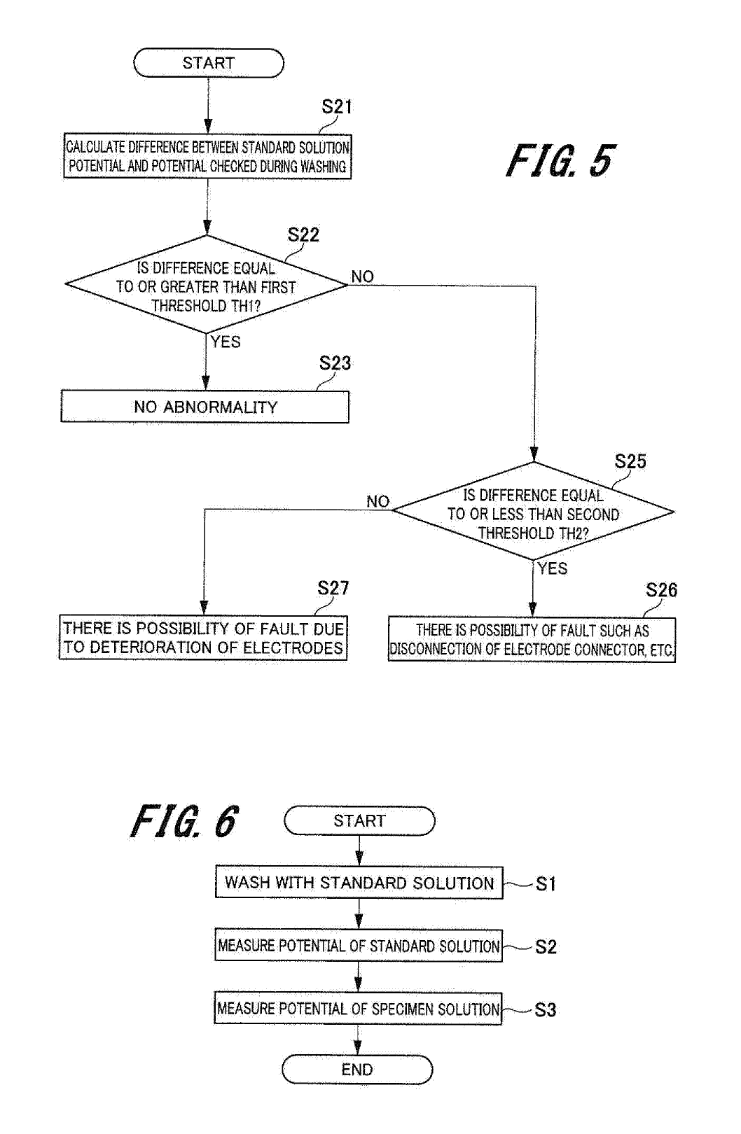

FIG. 1
161 SIGNAL PROCESSING UNIT
162 CONTROL UNIT
163 OUTPUT UNIT
FIG. 2
S11 SUPPLY STANDARD SOLUTION TO DILUTION TANK
S12 MEASURE POTENTIAL OF STANDARD SOLUTION
S13 DISCHARGE STANDARD SOLUTION FROM DILUTION TANK
S14 SUPPLY DILUENT TO DILUTION TANK
S15 MEASURE POTENTIAL OF DILUENT
S16 DISCHARGE DILUENT FROM DILUTION TANK
S17 SUPPLY DILUENT AND SPECIMEN TO DILUTION TANK
S18 MEASURE POTENTIAL OF SPECIMEN SOLUTION
S19 DISCHARGE SPECIMEN SOLUTION FROM DILUTION TANK
S20 CALCULATE ELECTROLYTE CONCENTRATION FROM MEASUREMENT
RESULTS
1 START
2 END
FIG. 3
S21 CALCULATE DIFFERENCE BETWEEN STANDARD SOLUTION
POTENTIAL AND POTENTIAL CHECKED DURING WASHING
S22 IS DIFFERENCE EQUAL TO OR GREATER THAN FIRST THRESHOLD
TH1?
S23 NO ABNORMALITY
S24 THERE IS POSSIBILITY OF ABNORMALITY
1 START
FIG. 4A
1 POTENTIAL
FIG. 4B
1 POTENTIAL
FIG. 4C
1 potential
FIG. 5
S21 CALCULATE DIFFERENCE BETWEEN STANDARD SOLUTION
POTENTIAL AND POTENTIAL CHECKED DURING WASHING
S22 IS DIFFERENCE EQUAL TO OR GREATER THAN FIRST THRESHOLD
TH1?
S23 NO ABNORMALITY
S25 IS DIFFERENCE EQUAL TO OR LESS THAN SECOND THRESHOLD
TH2?
S26 THERE IS POSSIBILITY OF FAULT SUCH AS DISCONNECTION OF ELECTRODE CONNECTOR, ETC.
S27 THERE IS POSSIBILITY OF FAULT DUE TO DETERIORATION OF ELECTRODES
1 START
FIG. 6
S1 WASH WITH STANDARD SOLUTION
S2 MEASURE POTENTIAL OF STANDARD SOLUTION
S3 MEASURE POTENTIAL OF SPECIMEN SOLUTION
1 START
2 END

What is claimed is:

1. An electrolyte measuring apparatus comprising:
a dilution tank;
a specimen supply unit configured to supply a specimen to the dilution tank;
a diluent supply unit configured to supply a diluent to the dilution tank;
a standard solution supply unit configured to supply a standard solution to the dilution tank;
a measuring unit configured to measure a potential of a liquid supplied to the dilution tank, by using an electrode section including a working electrode and a reference electrode; and
a control unit configured to measure a potential of the standard solution supplied from the standard solution supply unit to the dilution tank, a potential of the diluent supplied from the diluent supply unit to the dilution tank, and a potential of a specimen solution obtained by mixing, in the dilution tank, the diluent supplied from the diluent supply unit and the specimen supplied from the specimen supply unit, wherein
the control unit determines an electrolyte concentration of the specimen on the basis of a difference between the potential of the standard solution and the potential of the specimen solution, and determines presence/absence of an abnormality on the basis of a difference between the potential of the standard solution or the specimen solution and the potential of the diluent.

2. The electrolyte measuring apparatus according to claim 1, wherein, in a state where the control unit determines that the abnormality is present, when the difference between the potential of the standard solution or the specimen solution and the potential of the diluent is equal to or greater than a predetermined value, the control unit determines that there is a possibility of an abnormality due to deterioration of the working electrode and the reference electrode, and when the difference is less than the predetermined value, the control unit determines that there is a possibility of an abnormality due to breakage or disconnection of a cable or a connector connected to the electrode.

3. An electrolyte measuring method comprising:
a standard solution supplying step of supplying a standard solution to a dilution tank;
a standard solution measuring step of measuring a potential of the standard solution supplied to the dilution tank in the standard solution supplying step;
a standard solution discharging step of discharging the standard solution from the dilution tank after the standard solution measuring step;
a diluent supplying step of supplying a diluent to the dilution tank after the standard solution discharging step;
a diluent measuring step of measuring a potential of the diluent supplied to the dilution tank in the diluent supplying step;
a diluent discharging step of discharging the diluent from the dilution tank after the diluent measuring step;
a specimen solution supplying step of supplying the diluent and a specimen to the dilution tank to obtain a specimen solution after the diluent discharging step;
a specimen solution measuring step of measuring a potential of the specimen solution supplied to the dilution tank in the specimen solution supplying step;
a specimen solution discharging step of discharging the specimen solution from the dilution tank after the specimen solution measuring step; and
an electrolyte concentration determining step of determining an electrolyte concentration of the specimen on the basis of a difference between the potential of the standard solution measured in the standard solution measuring step and the potential of the specimen solution measured in the specimen solution measuring step, and determining presence/absence of an abnormality on the basis of a difference between the potential of the standard solution measured in the standard solution measuring step or the potential of the specimen solution measured in the specimen solution measuring step and the potential of the diluent measured in the diluent measuring step.

4. An electrolyte measuring method according to claim 3, wherein, in a state where it is determined that the abnormality is present, when the difference between the potential of the standard solution or the specimen solution and the potential of the diluent is equal to or greater than a predetermined value, it is determined that there is a possibility of an abnormality due to deterioration of an electrode for measuring a potential of a liquid, and when the difference is less than the predetermined value, it is determined that there is a possibility of an abnormality due to breakage or disconnection of a cable or a connector connected to the electrode.
